(19) United States
(12) Patent Application Publication
(10) Pub. No.: US 2010/0166481 A1
(43) Pub. Date: Jul. 1, 2010

(54) PAPER WIDTH DETECTION APPARATUS AND IMAGE FORMING APPARATUS

(75) Inventor: Masayuki Yamada, Tokyo (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/637,847

(22) Filed: Dec. 15, 2009

(30) Foreign Application Priority Data
Dec. 26, 2008 (JP) 2008-335252

(51) Int. Cl. B41J 11/00; B65H 20/02

(52) U.S. Cl. 400/621; 226/168

(57) ABSTRACT

There is provided a paper width detection apparatus including a plurality of lever members lined in parallel in a paper width direction of a recording paper roll, each lever member being rotatably arranged on a same center axis, a detecting unit for detecting a rotation state of the lever member, and a determination unit for determining a paper width of the recording paper roll based on a detection result. One lever member of the plurality of lever members rotates in a first rotating direction about the center axis by contacting an outer peripheral part of a holding unit for holding both ends of the recording paper roll, and another lever member positioned on an inner side in the paper width direction facing the recording paper roll than the lever member contacting the holding unit rotates in conjunction with the lever member contacting the outer peripheral part of the holding unit.

### BACKGROUND OF THE INVENTION

1. Field of the Invention

The present invention relates to a paper width detection apparatus and an image forming apparatus.

2. Description of the Related Art

In an image forming apparatus such as a printer and a copying machine, a cut paper, which is cut to a predetermined size in advance, and a roll paper, which is rolled up to a rolled form, are used as a recording medium for recording images. Recently, with the spread of digital cameras, the roll paper, which is advantageous in terms of cost in high quality printing, is widely used. The roll paper is formed by rolling up a long recording paper on a paper core that acts as a rolling core, and is pulled out by a necessary amount for every printing and conveyed to a printing unit, and then cut to a predetermined size and discharged from a discharging unit after printing is finished.

With the spread of the roll paper, type and size such as width dimension of the roll paper have diversified. On the other hand, an image forming apparatus capable of loading roll papers of different size tends to increase. In such image forming apparatus, a setting and a driving method suited to the size to be used are selected, where a majority of the image forming apparatus includes a size detection means for detecting the size of the roll paper. The image forming apparatus is able to automatically perform setting suited to the paper size to be used, based on the detection result of the size detection means.

For instance, Japanese Patent Application Laid-Open No. 2005-320101 discloses a size detection means configured to include a mirror piece that oscillates by a cam arranged at an end face of a flange member for holding the roll paper, a light source for irradiating light to the mirror piece, and a sensor for detecting a reflected light of the mirror piece. Such size detection means calculates the time between the time point the reflected light is detected in moving towards right and the time point the reflected light is detected in moving towards left in one period in which the mirror piece oscillates to the left and the right, and calculates a paper width from the relevant time.

Furthermore, Japanese Patent Publication No. 2848062 discloses a paper size detection device including a size detection mechanism at a predetermined position of a downstream portion of a conveyance roller device. Such size detection mechanism is arranged at a joining portion of a paper conveyance path, and detects the paper size by being configured with a plurality of sensors arranged with respect to the paper conveyance path.

### SUMMARY OF THE INVENTION

However, the size detection means described in Japanese Patent Application Laid-Open No. 2005-320101 has an issue in that the mirror piece may not be oscillated unless the flange member is rotated, and thus lacks in immediate decision property of the paper size. Furthermore, the addition of the mechanism such as the cam and the mirror piece is desired with respect to the flange member, and high precision is desired for the configuration thereof. When detecting the recording paper being conveyed in the paper conveyance path as described in Japanese Patent Publication No. 2848062, the paper size is not able to be detected until the paper passes the position where the sensor is arranged, and thus lacks in immediate decision property. Furthermore, periodic maintenance is necessary since paper powder, and the like in the paper conveyance path tends to accumulate in a light emitting unit and a light receiving unit.

The present invention has been made in view of the above issue, and it is desirable to provide a novel and improved paper width detection apparatus and an image forming apparatus capable of immediately judging the paper size and reliably detecting the paper size with a simple configuration.

According to an embodiment of the present invention, there is provided a paper width detection apparatus including a plurality of lever members lined in parallel in a paper width direction of a recording paper roll attached to a recording paper roll loading unit, each lever member being rotatably arranged on a same center axis, a detecting unit for detecting a rotation state of the lever member, and a determination unit for determining a paper width of the recording paper roll based on a detection result detected by the detecting unit. One lever member of the plurality of lever members rotates in a first rotating direction about the center axis by contacting an outer peripheral part of a holding unit for holding both ends of the recording paper roll, and another lever member positioned on an inner side in the paper width direction facing the recording paper roll than the lever member contacting the holding unit rotates in conjunction with the lever member contacting the outer peripheral part of the holding unit.

According to the present invention, one lever member of a plurality of lever members contacts an outer peripheral part of a holding unit and rotates, and another lever member, which is positioned on an inner side in a paper width direction than the contacting lever member, rotates in conjunction therewith. The paper width direction herein described is the width in a direction orthogonal to the rolling direction of the recording paper roll. The inner side in the paper width direction having an arbitrary lever member as a reference is the recording paper roll side, and the outer side in the paper width direction is the side opposite to the side arranged with the recording paper roll. A detecting unit detects the rotated lever member, and a determination unit determines the paper width of the recording paper roll based on the detection result of the detecting unit. Thus, the paper width of the recording paper roll can be detected with a simple configuration. Furthermore, the lever member can be prevented from contacting the recording paper roll by rotating the lever member positioned on the inner side in the paper width direction than the lever member contacting the outer peripheral part of the holding unit in conjunction.

Here, a second lever member positioned on an outer side in the paper width direction of the lever members adjacent in the paper width direction includes a projection projecting towards a first lever member positioned on the inner side in the paper width direction. When the second lever member rotates in the first rotating direction, the projection of the second lever member contacts the first lever member, and the first lever member rotates with the second lever member.

Moreover, the lever member includes a main body unit having a contacting part, which contacts the outer peripheral part of the holding unit, at one end and a through-hole to be inserted with the center axis on another end, and a back end which is coupled to the other end of the main body unit and which rotation state is detected by the detecting unit. At this time, the determination unit determines the paper width of the recording paper roll based on number of detections the back end is detected by the detecting unit by the rotation of the lever member.

Furthermore, one lever member of the plurality of lever members may contact an outer peripheral surface of a flange unit and may rotate in the first rotating direction when the recording paper roll loading unit is inserted to a housing from an initial state in which the lever member is drooped such that the contacting part is positioned on an upper side than a center of rotation of the recording paper roll loading unit. The one or more rotated lever members may return to the initial state when the recording paper roll loading unit is pulled out from the housing.

Moreover, the paper width detection apparatus may further include an elastic member for biasing the lever member in a second direction opposite to the first rotating direction.

Moreover, according to another embodiment of the present invention, there is provided an image forming apparatus including a recording paper roll loading unit, detachably arranged with respect to a housing, for accommodating a recording paper roll formed by rolling up a recording paper to a roll-form, a paper width detection mechanism for detecting a paper width of the recording paper roll accommodated in the recording paper roll loading unit, a paper conveying unit for conveying the recording paper, a printing unit for performing a printing process on the recording paper conveyed by the paper conveying unit, and a cutting unit for cutting a printed region printed by the printing unit of a recording medium. The paper width detection mechanism includes, a plurality of lever members lined in parallel in the paper width direction of the recording paper roll attached to the recording paper roll loading unit, each lever member being rotatably arranged on a same center axis, a detecting unit for detecting a rotation state of the lever member, and a determination unit for determining the paper width of the recording paper roll based on a detection result detected by the detecting unit. One lever member of the plurality of lever members rotates in a first rotating direction about the center axis by contacting an outer peripheral part of a holding unit for holding both ends of the recording paper roll, and another lever member positioned on an inner side in the paper width direction facing the recording paper roll than the lever member contacting the holding unit rotates in conjunction with the lever member contacting the outer peripheral part of the holding unit.

Here, the holding unit may include a fixed unit inserted to a center part of the recording paper roll to act as a rotation shaft of the recording paper roll, and a movable unit on a circular plate, coupled to the fixed unit, for regulating an end face position of the recording paper roll. At this time, a guide unit projected or recessed in a radial direction is formed along a peripheral direction at an outer peripheral part, which is an outer edge of the movable unit.

According to the embodiments of the present invention described above, a paper width detection apparatus and an image forming apparatus capable of immediately judging the paper size and reliably detecting the paper size with a simple configuration can be provided.

### BRIEF DESCRIPTION OF THE DRAWINGS

FIG. 1 is a cross-sectional view showing a schematic configuration of an image forming apparatus according to an embodiment of the present invention;

FIG. 2 is a perspective view showing a recording paper roll and a holding unit for holding the same according to the embodiment;

FIG. 3 is a partial perspective view showing a schematic configuration of a paper width detection mechanism according to the embodiment;

FIG. 4 is a partial perspective view showing the configuration of the paper width detection mechanism according to the embodiment in detail;

FIG. 5 is an exploded perspective view showing a configuration of a lever member of the paper width detection mechanism according to the embodiment;

FIG. 6 is an exploded perspective view showing a configuration of a lever member of the paper width detection mechanism according to the embodiment;

FIG. 7 is an exploded perspective view showing a configuration of a lever member of the paper width detection mechanism according to the embodiment;

FIG. 8 is a plan view showing the lever member according to the embodiment;

FIG. 9 is a bottom view showing the lever member according to the embodiment;

FIG. 10 is a perspective view showing a configuration of a holder according to the embodiment;

FIG. 11 is a partial perspective view showing an outline of a usage state of the paper width detection mechanism according to the embodiment;

FIG. 12 is an explanatory view showing a state in which a recording paper roll loading unit is attached to a housing of the image forming apparatus;

FIG. 13 is an explanatory view showing the operation of the lever member in the attachment of the recording paper roll loading unit to the housing;

FIG. 14 is an explanatory view showing a state in which a first lever member is contacting a flange unit;

FIG. 15 is an explanatory view showing a state in which a second lever member is contacting a flange unit; and

FIG. 16 is an explanatory view showing a state in which a third lever member is contacting a flange unit.

### DETAILED DESCRIPTION OF THE EMBODIMENT

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

The present embodiment will be described in the following order.

1. Configuration of image forming apparatus
2. Configuration of paper width detection mechanism (overall configuration, and characteristics of lever member and holder)
3. Detecting operation of paper width detection mechanism

### [Configuration of Image Forming Apparatus]

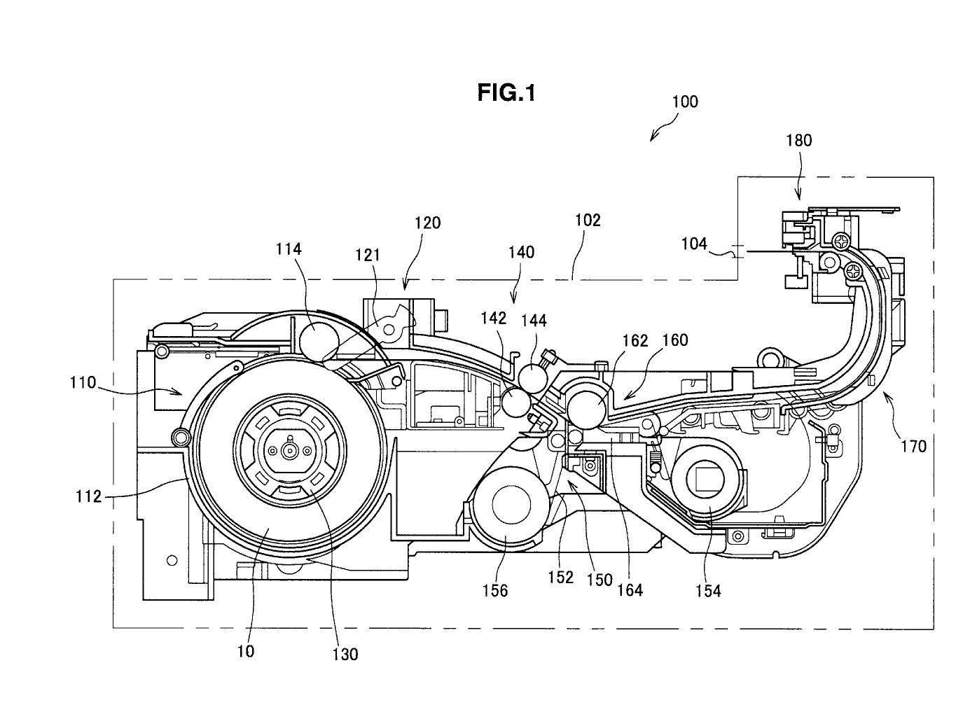

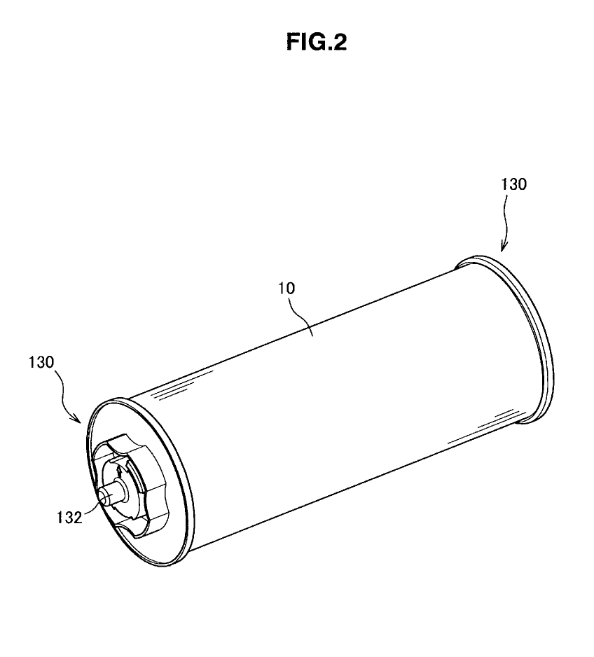

First, a schematic configuration of an image forming apparatus 100 equipped with a paper width mechanism 120 according to the embodiment of the present invention will be described based on FIGS. 1 and 2. FIG. 1 is a cross-sectional view showing a schematic configuration of the image forming apparatus 100 according to the present embodiment. FIG. 2 is a perspective view showing a recording paper roll 10 and a holder 130 for holding the same according to the present embodiment.

A sublimation thermal printer device, as shown in FIG. 1, may be used for the image forming apparatus 100 equipped with the paper width detection mechanism 120 according to the present embodiment. The sublimation thermal printer device is an image forming apparatus that uses an exothermic energy of when current is carried to a heat generating element in a thermal head to sublimate a sublimation dye applied on an ink ribbon, and transfer and print on a recording paper. As shown in FIG. 1, such image forming apparatus 100 includes a recording paper roll loading unit 110, the paper width detection mechanism 120, a paper conveying unit 140, an ink supplying unit 150, a printing unit 160, a fold-back unit 170, and a cutter unit 180.

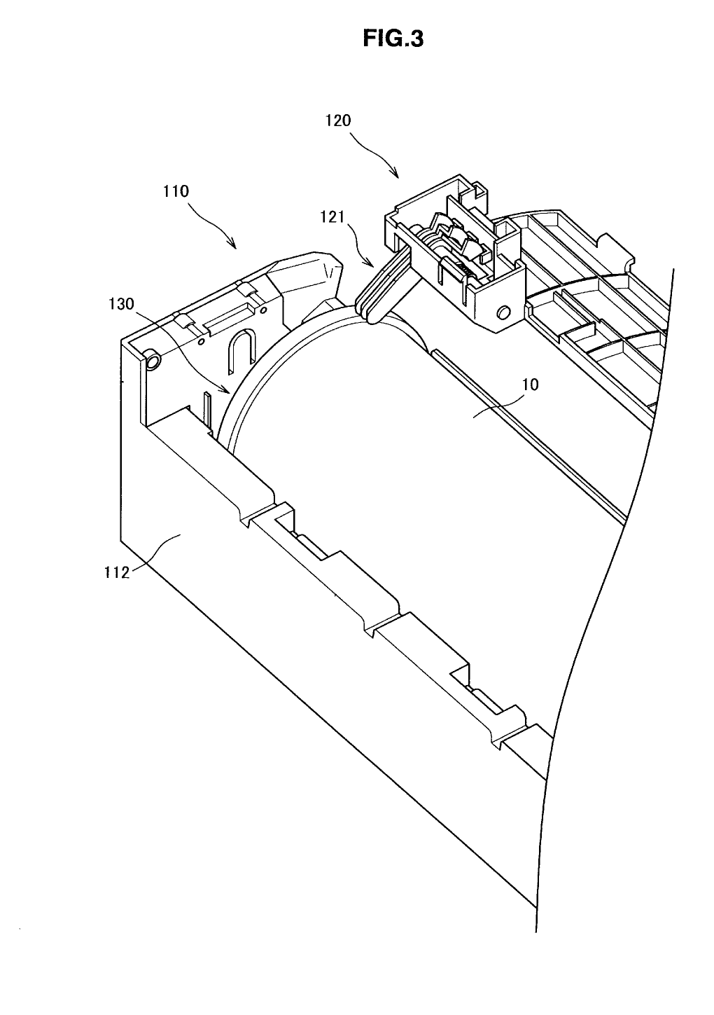

The recording paper roll loading unit 110 is a mechanism for accommodating a recording paper roll 10, and is detachably arranged with respect to a housing 102 of the image forming apparatus 100. The recording paper roll loading unit 110 includes an accommodating portion 112 for accommodating the recording paper roll 10. The recording paper roll 10 is formed by rolling up a recording paper on a tubular shaft part to a rolled form. As shown in FIG. 3, the holder 130 is attached to both ends of the recording paper roll 10 to rotatably attach the recording paper roll 10 to the recording paper roll loading unit 110. The accommodating portion 112 is formed to a substantially semicircular recess along the shape of an outer circumferential surface of the recording paper roll 10, and covers part of the outer circumferential surface of the accommodated recording paper roll 10. The recording paper roll loading unit 110 rotatably supports a supporting portion 132 of the holder 130 attached to the recording paper roll. A paper feeding roller 114 for feeding the recording paper forming the recording paper roll 10 to a conveyance path is arranged so as to contact an outermost circumferential surface of the recording paper roll 10 accommodated in the accommodating portion 112. The detailed configuration of the holder 130 will be hereinafter described.

The paper width detection mechanism 120 detects the paper width of the recording paper roll 10 accommodated in the recording paper roll loading unit 110. The paper width detection mechanism 120 can detect the paper width of the accommodated recording paper roll 10 by contacting the holder 130, which is a holding unit for holding the recording paper roll 10. The detailed configuration of the paper width detection mechanism 120 will be hereinafter described.

The paper conveying unit 140 is a mechanism for conveying the recording paper during the printing operation and the paper discharging operation, and includes a pinch roller 142 and a capstan 144. The pinch roller 142 and the capstan 144 are pressed and contacted to each other, where the recording paper passing through the pressed and contacted portion of the pinch roller 142 and the capstan 144 is conveyed by the rotation of the pinch roller 142 and the capstan 144. For instance, the recording paper conveyed by the paper feeding roller 114 from the recording paper roll loading unit 110 is conveyed in the forward direction to be guided to the printing unit 160 side, or the recording paper of the conveyance path is conveyed in the reverse direction to be wounded by the recording paper roll 10. The paper conveying unit 140 is accurately forward/reverse rotation controlled by a control unit (not shown).

The ink supplying unit 150 supplies ink used to form images on the recording paper. The ink supplying unit 150 includes an ink ribbon 152, a supply reel 154, and a winding reel 156. The ink ribbon 152 is color coded for every ink color. The ink ribbon 152 is pulled out by the supply reel 154, passed on a platen roller 162, and conveyed and wounded by the winding reel 156.

The printing unit 160 is a mechanism for performing a printing process on the recording paper, and includes the platen roller 162, and a print head 164. The platen roller 162 is a roller member used in printing. The print head 164 includes a heat generating element for sublimating the sublimation dye of the ink ribbon 152, and is arranged at a position facing the platen roller 162 with the conveyance path of the recording paper in between. The print head 164 is configured to be movable between a printing position where the recording paper and the ink ribbon 152 are pressed with the platen roller 162, and a standby position where the pressing on the recording paper of the ink ribbon 152 is released by being separated from the platen roller 162.

The fold-back unit 170 is a paper conveyance path for changing the conveying direction of the recording paper printed in the printing unit 160. As shown in FIG. 1, the fold-back unit 170 may be formed to a substantially U-shaped path. According to such shape, the direction of the recording paper that entered the fold-back unit 170 can be changed, and the recording paper can be discharged. With the arrangement of the fold-back unit 170, a limited space in the apparatus can be effectively utilized, and an insert/exit direction of the recording paper roll loading unit 110 and an opening direction of a discharge port 104 can be faced in the same direction. The operability of the image forming apparatus 100 thus can be enhanced.

The cutter unit 180 is a mechanism for cutting the recording paper, and is arranged at the discharge port 104 of the image forming apparatus 100. The cutter unit 180 cuts the recording paper to a printed region and a non-printed region in a length direction of the recording paper.

When information on the image to be printed on the recording paper is input, the image forming apparatus 100 having the above configuration feeds the recording paper from the recording paper roll loading unit 110 by means of the paper feeding roller 114, and conveys the recording paper to the printing unit 160 by means of the paper conveying unit 140. When the recording paper reaches the printing unit 160, the print head 164 approaches the platen roller 162, and the ink ribbon 152 pressure contacts the recording paper. The print head 164 selectively current-carry drives the heat generating element based on tone data to sublimate the ink on the ink ribbon 152 and transfer to the recording paper. The image thereby forms on the recording paper. Thereafter, the recording paper is passed through the fold-back unit 170 and cut to a predetermined size by the cutter unit 180, and the recording paper including the printed region is discharged from the discharge port 104.

The schematic configuration of the image forming apparatus 100 according to the present embodiment has been described above. The image forming apparatus 100 according to the present embodiment can replace to the recording paper roll 10 of a different size to the recording paper roll loading unit 110 and use the same. The image forming apparatus 100 according to the present embodiment includes the paper width detection mechanism 120 to automatically detect the paper size (paper width in the present embodiment) of the recording paper roll 10 accommodated in the recording paper roll loading unit 110.

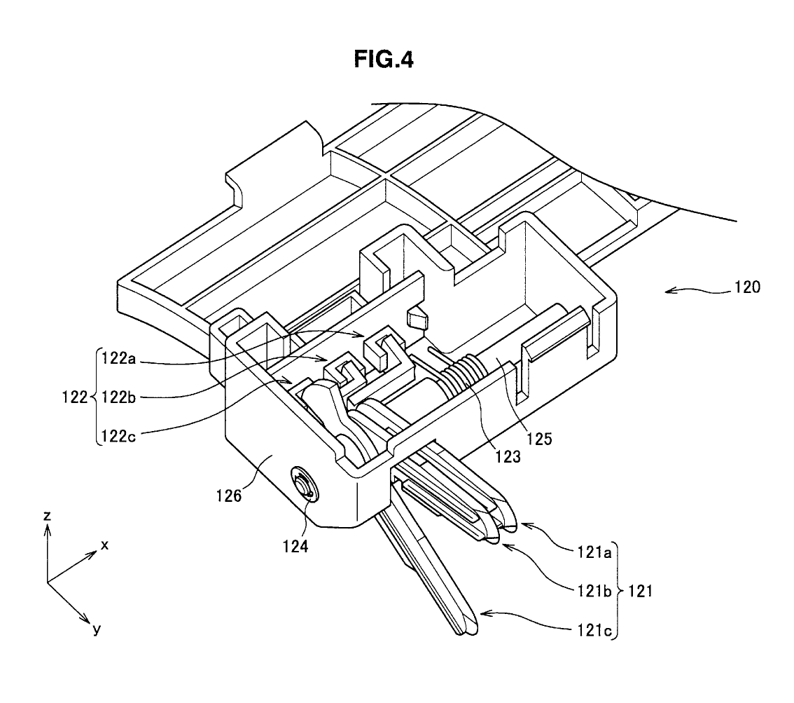

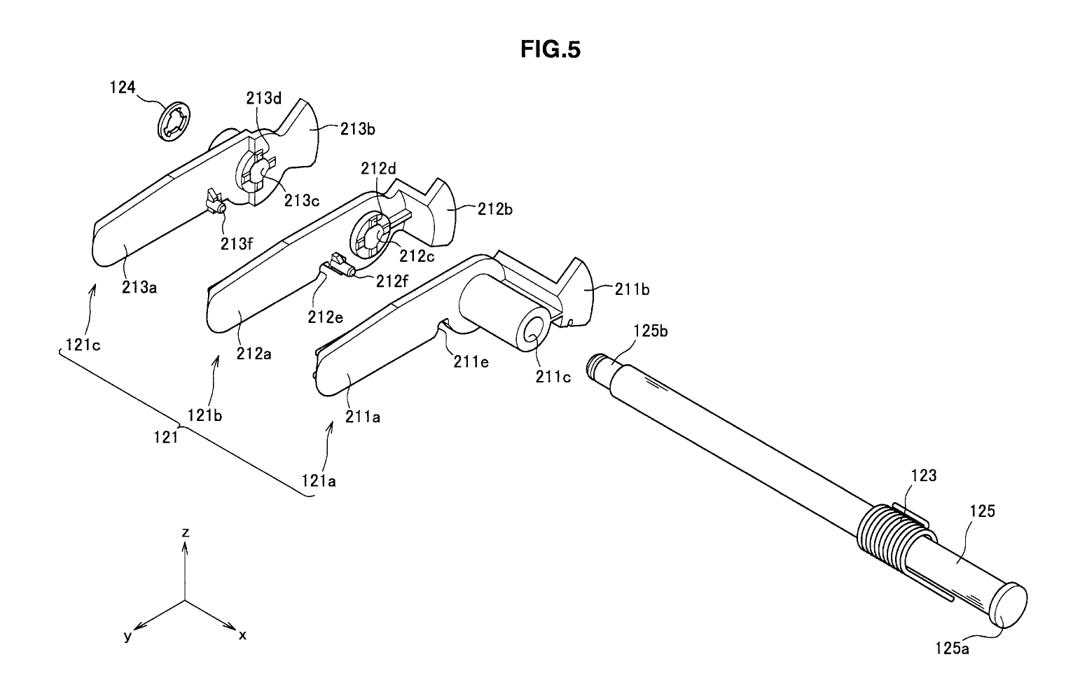

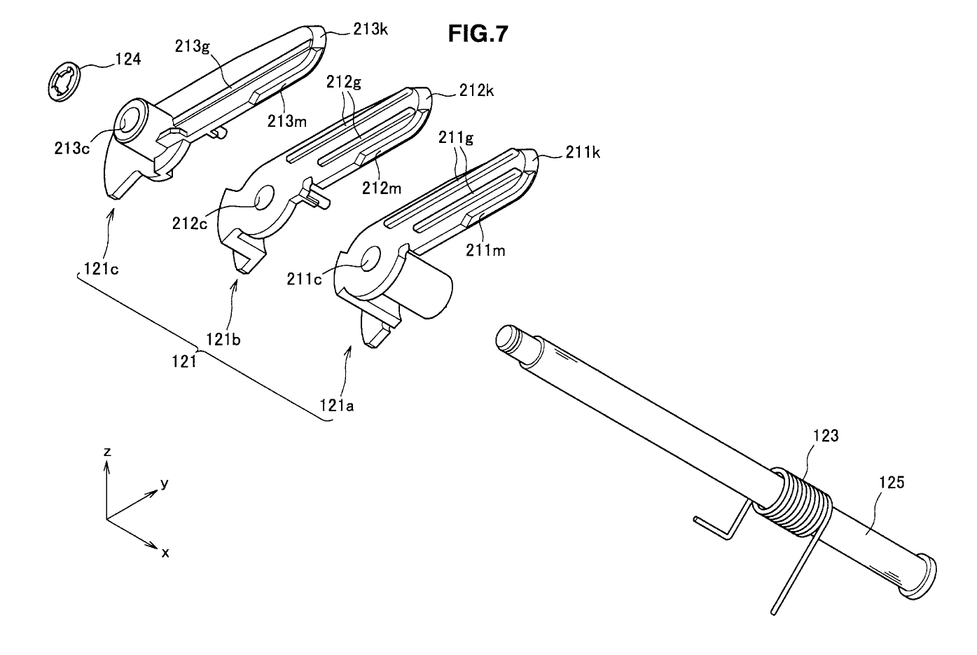

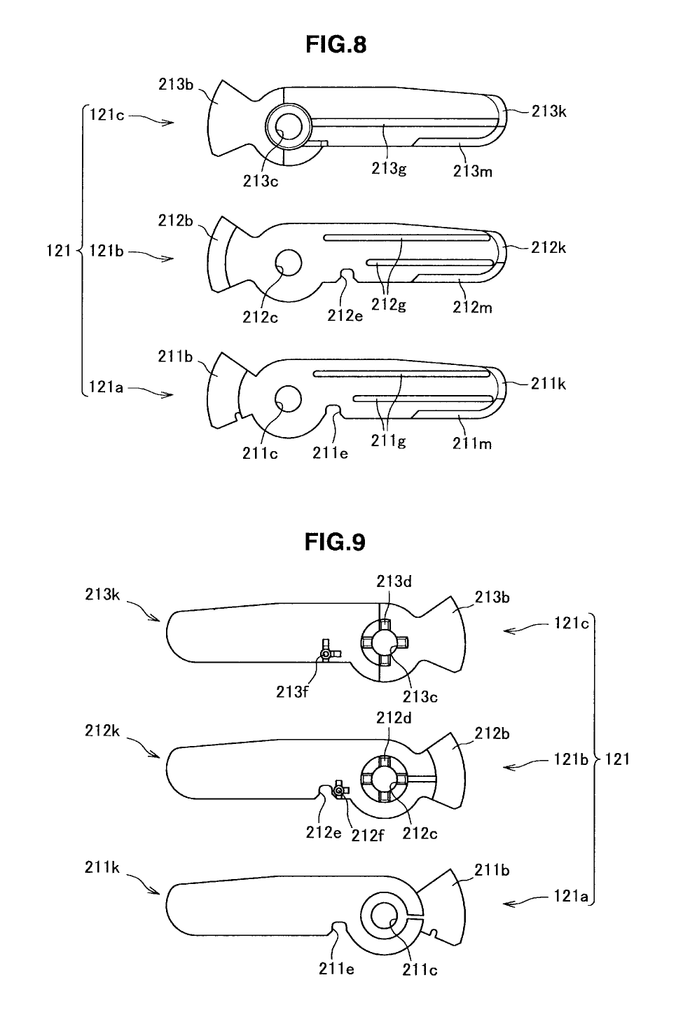

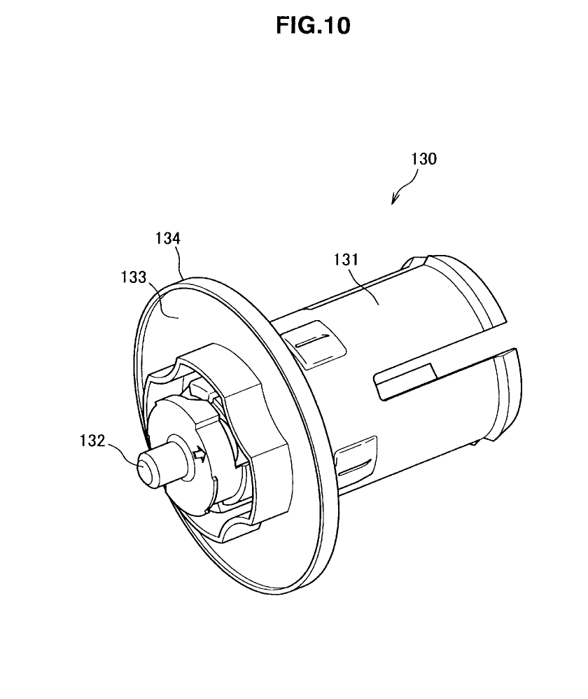

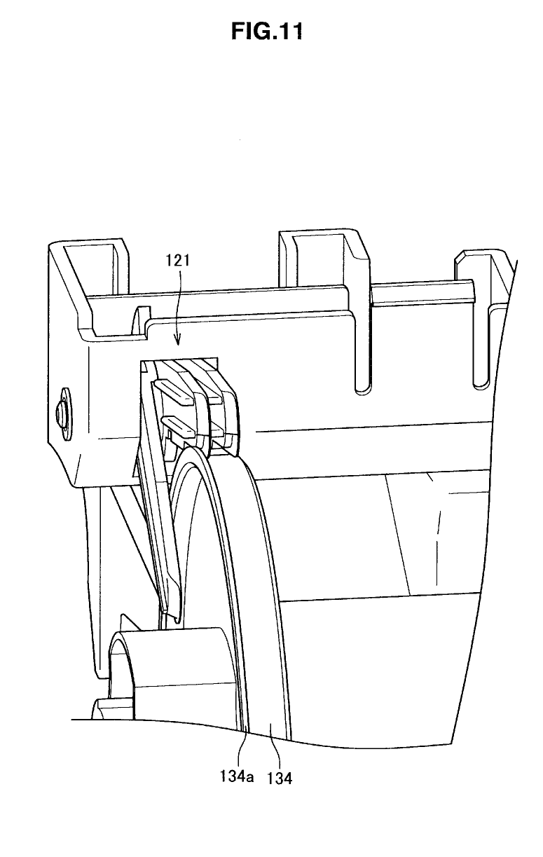

The configuration of the paper width detection mechanism 120 according to the present embodiment will be described in detail based on FIGS. 3 to 11. FIG. 3 is a partial perspective view showing a schematic configuration of the paper width detection mechanism 120 according to the present embodiment. FIG. 4 is a partial perspective view showing the configuration of the paper width detection mechanism 120 according to the present embodiment in detail. FIGS. 5 to 7 are exploded perspective views showing a configuration of a lever member of the paper width detection mechanism 120 according to the present embodiment. FIG. 8 is a plan view showing the lever member according to the present embodiment. FIG. 9 is a bottom view showing the lever member according to the present embodiment. FIG. 10 is a perspective view showing a configuration of the holder 130 according to the present embodiment. FIG. 11 is a partial perspective view showing an outline of a usage state of the paper width detection mechanism 120 according to the present embodiment.

### [Configuration of Paper Width Detection Mechanism]

As shown in FIG. 3, the paper width detection mechanism 120 according to the present embodiment is arranged on the upper side of the recording paper roll 10 accommodated in the recording paper roll loading unit 110. The paper width detection mechanism 120 includes three lever members 121, and can detect the paper size of three types. The distal end portion of one of the lever members 121 is arranged to contact the outer peripheral portion of the holder 130. The paper width detection mechanism 120 detects the paper width of the recording paper roll 10 accommodated in the recording paper roll loading unit 110 based on the rotation position of each lever member 121.

More specifically, the paper width detection mechanism 120 is configured by the lever member 121, a detecting unit 122, a torsion spring 123, and a supporting shaft 125, as shown in FIG. 4.

The lever member 121 is a plate-shaped member that rotates according to the paper size of the recording paper roll 10 accommodated in the recording paper roll loading unit 110. The lever member 121 according to the present embodiment includes a first lever member 121a, a second lever member 121b, and a third lever member 121c arranged in order from the inner side towards the outer side in the paper width direction. Among such lever members 121, one lever member 121 contacts the outer peripheral part of the holder 130 attached to the recording paper roll 10, and rotates according to the paper width of the recording paper roll 10. Each lever member 121 rotates in conjunction with the lever member 121 positioned on the outer side in the paper width direction of the recording paper roll 10 than itself. The detailed configuration of the lever member 121 will be hereinafter described.

The detecting unit 122 detects the rotation of the lever member 121. A detection element such as a photosensor and a magnetic sensor, or a detection circuit substrate using a micro-switch and a lead switch may be used for the detecting unit 122. The detecting unit 122 is arranged on a detection circuit substrate arranged on an inner wall surface of the supporting portion including a pair of side plates facing each other, and a coupling plate for coupling the side plates. The detecting unit 122 is arranged at one to one with the lever member 121. The detecting unit 122 is arranged at a position facing a back end (e.g., reference numerals 211b, 212b, 213b in FIG. 5) of the lever member 121 in a y-axis direction when the lever member 121 is rotated. Alternatively, the detecting unit 122 may be arranged to face the back end of the lever member 121 in an x-axis direction. When a contacting part of the lever member 121 contacts the outer peripheral surface of the holder 130 and displaces in the rotating direction, the back end of the lever member 121 is sandwiched by the inner wall surface of the supporting portion, that is, the portion surrounded by the side plates and the coupling plate. Thus, the detecting unit 122 including the photosensor is light shielded, and the rotation state of the lever member 121 is detected.

The torsion spring 123 is an elastic member for biasing the lever member 121. The torsion spring 123 has the supporting shaft 125 inserted to the inside of the wounded portion, and is supported by the supporting shaft 125 with the lever member 121. With the reception of the biasing force of the torsion spring 123, the lever member 121 is in a state in which the contacting part is drooped when not contacting the outer peripheral part of the holder 130, and is biased with respect to the outer peripheral part when contacting the outer peripheral part of the holder 130. The contacting part of the lever member 121 can freely rotate against the biasing force of the torsion spring 123. If the lever member 121 is arranged such that the contacting part droops by its own weight when not contacting the outer peripheral part of the holder 130, the torsion spring 123 may be omitted.

The supporting shaft 125 is a shaft for supporting the lever member 121 and the torsion spring 123. The supporting shaft 125 has a locking unit 125a that locks the supporting shaft 125 to the accommodating portion 126 at one end, and a groove 125b at the other end. The supporting shaft 125 is inserted to a through-hole passing in the paper width direction of the recording paper roll 10 formed in the accommodating portion 126, and is fixed to the accommodating portion 126 by engaging a fixing member 124 such as a retaining ring to the groove 125b. In this case, the lever member 121 and the torsion spring 123 are accommodated inside the accommodating portion 126. The detecting unit 122 is arranged inside the accommodating portion 126 in correspondence to the lever member 121.

The paper width detection mechanism 120 further includes a determination unit (not shown) for determining the size of the recording paper roll 10 accommodated in the recording paper roll loading unit 110 based on the detection result of the rotation state of the lever member 121 by the detecting unit 122. The determination unit is a micro-computer etc. arranged on the detection circuit substrate including the detecting unit 122. The determination unit determines the size of the recording paper roll 10 according to the number of back ends 211b, 212b, and 213b of the lever member 121 detected by the detecting unit 122 by the rotation.

### [Configuration of Lever Member]

The configuration of the lever member 121 of the paper width detection mechanism 120 will now be more specifically described based on FIGS. 5 to 9. With respect to the lever member 121, the x-axis positive direction side is the plane, x-axis negative direction side is the bottom surface, y-axis positive direction side is the front surface, y-axis negative direction side is the rear surface, z-axis positive direction side is the upper side surface, and z-axis negative direction side is the lower side surface.

The lever member 121 is a light plate-shaped member integrally formed from hard resin. Lighter weight and lower cost can be achieved by using such lever member 121. The lever member 121 includes a main body unit (211a, 212a, 213a), a back end (211b, 212b, 213b), and a through-hole (211c, 212c, 213c).

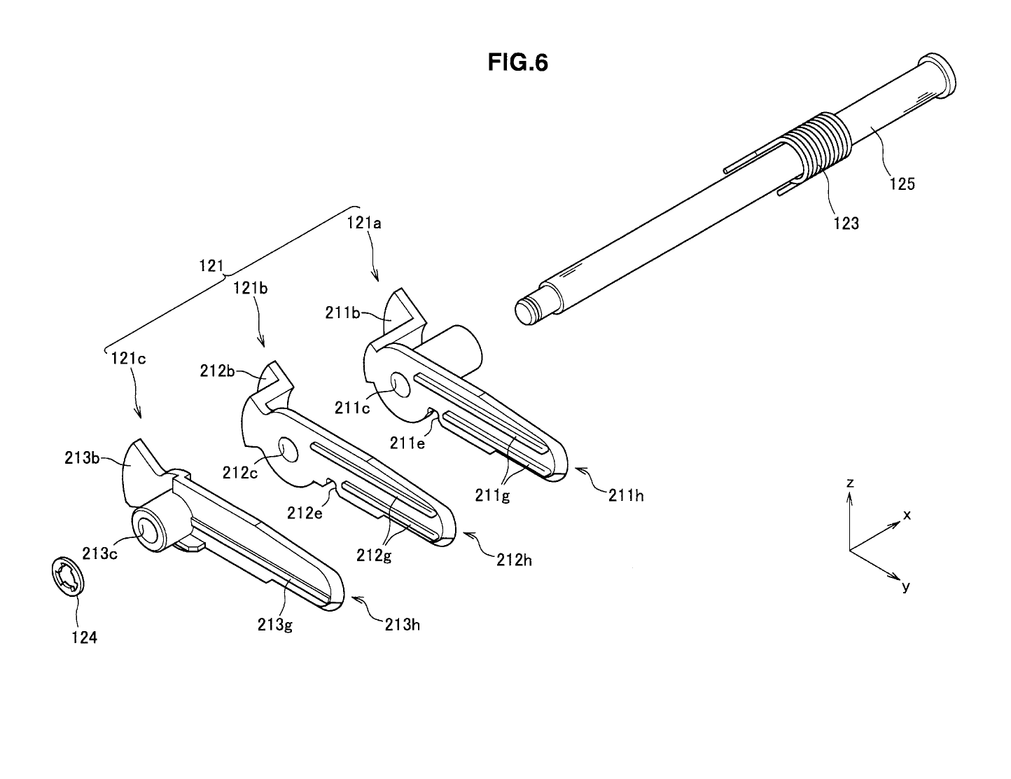

The main body unit 211a, 212a, 213a is a plate-shaped member of substantially rectangular shape in which the front surface and the rear surface are rounded. The plane side of the main body unit 211a, 212a, and 213a is a flat surface, as shown in FIGS. 5 and 9. The bottom surface side of the main body unit 211a, 212a, and 213a includes a flat portion and a thin-thickness portion (211m, 212m, 213m) having a thickness in the x-axis direction smaller than the flat portion, as shown in FIGS. 6 to 8. The flat portion on the bottom surface side of the main body unit 211a, 212a, and 213a also has the thickness of the front surface portion (211h, 212h, 213h) become smaller towards the rounded distal end portion. A rib (211g, 212g, 213g) extending in the y-axis direction is formed at the flat portion on the bottom surface side of the main body unit 211a, 212a, and 213a to reinforce the main body unit 211a, 212a, and 213a. The thin-thickness portion 211m, 212m, 213m of the main body unit 211a, 212a, and 213a contacts the outer peripheral surface of the holder 130 holding the recording paper roll 10.

The through-hole 211c, 212c, 213c is formed at one side (y-axis negative direction side) of the main body unit 211a, 212a, 213a coupled with the back end 211b, 212b, 213b. The supporting shaft 125 is inserted to the through-hole 211c, 212c, and 213c. Four protrusions (212d, 213d), for example, are formed at the periphery of the through-hole 212c, 213c, as shown in FIG. 5, at the through-hole 212c, 213c of the second lever member 121b and the third lever member 121c. The protrusions 212d and 213d are provided to reduce the area of the portion having the possibility of contacting the adjacent lever member 121.

The main body unit 211a, 212a, 213a of the lever member 121 includes an engaging portion and an engaged portion to cooperatively rotate the adjacent member 121. The engaging portion is a recess (211e, 212e) formed on the lower side surface of the first lever member 121a and the second lever member 121b. The engaged portion is a projection (212f, 213f) arranged on the lower side surface of the second lever member 121b and the third lever member 121c.

The recess 211e of the first lever member 121a engages the projection 212f projecting in the x-axis positive direction side of the second lever member 121b, and the recess 212e of the second lever member 121b engages the projection 213f projecting in the x-axis positive direction side of the third lever member 121c. As shown in FIG. 5, the recesses 211e, 212e opened in the z-axis negative direction have the projections 212f, 213f contact the recesses 211e, 212e in the z-axis positive direction when the lever member 121 positioned on the outer side in the paper width direction than itself rotates along the outer peripheral surface of the holder 130. The recesses 211e, 212e are pushed up by the projections 212f, 213f. Thus, the lever member 121 can rotate itself in conjunction with the lever member 121 positioned on the outer side in the paper width direction (x-axis positive direction) than itself.

In other words, the projections 212f, 213f arranged on the second lever member 121b and the third lever member 121c transmit the power for rotating the lever members 121a, 121b to the lever members 121a, 121b adjacent on the inner side in the paper width direction. If the biasing force of the torsion spring 123 is also transmitted only to the lever member 121 positioned at the innermost part in the paper width direction by coupling the adjacent lever member 121, the biasing force can be transmitted to the adjacent lever member 121.

The back end 211b, 212b, 213b is coupled to the rear surface side of the main body unit 211a, 212a, and 213a. The back end 211b, 212b, and 213b may be a fan-shaped plate member, as shown in FIGS. 8 and 9. The back end 211b, 212b, 213b is arranged to be sandwiched by and face the inner wall surface of the supporting portion for supporting the detecting unit 122.

As shown in FIGS. 5 to 7, such lever member 121 has the through-holes 211c, 212c, 213c inserted to the supporting shaft 125 inserted with the torsion spring 123 in the order of the first lever member 121a, the second lever member 121b, and the third lever member 121c.

### [Configuration of Holder]

The paper width detection mechanism 120 determines the paper width by detecting the position of the outer peripheral part of the holder 130 holding the recording paper roll 10 accommodated in the recording paper roll loading unit 110. As shown in FIG. 10, the holder 130 includes a fixed bobbin 131 that is inserted to the rolling core of the recording paper roll 10 and acts as a rotation shaft, and a movable bobbin 133 for regulating the position of the end face of the recording paper roll 10. The fixed bobbin 131 is arranged with a supporting shaft 132 that projects out in a substantially perpendicular direction with respect to the end face of the recording paper roll 10. A flange unit 134 having a predetermined width in the x-axis direction is arranged at an outer edge of the movable bobbin 133.

The lever member 121 contacts the flange unit 134. The position of the flange unit 134 of when the recording paper roll 10 is accommodated in the recording paper roll loading unit 110 displaces in the paper width direction according to the paper width of the recording paper roll 10 to which the holder 130 is attached. The lever member 121 that contacts the flange unit 134 of the holder 130 and the lever member 121 positioned on the inner side in the paper width direction (x-axis positive direction side) than such lever member 121 rotates in a counterclockwise direction, as shown in FIG. 11. The lever member 121 that does not contact the flange unit 134, the lever member 121 being positioned on the outer side in the paper width direction (x-axis negative direction side) than the lever member 121 that contacts the flange unit 134, does not displace from the initial state and droops.

A radially projecting guide unit 134a may be arranged along a circumference in the x-axis negative direction side of the flange unit 134. The guide unit 134a may be arranged on the outer side in the paper width direction of the flange unit 134. With the arrangement of such guide unit 134a, even if the supporting shaft 132 of the holder 130 slightly rattles, the lever member 121 can be stably sled on the peripheral surface of the flange unit 134 without being influenced by such rattling. Thus, the possibility of mistaken detection by the paper width detection mechanism 120 can be lowered as much as possible. The diameter of the flange unit 134 is formed to be greater than the diameter at the outermost part of the recording paper roll 10. Accordingly, the lever member 121 and the surface of the recording paper roll 10 do not contact when the lever member 121 at the position facing the recording paper roll 10 rotates.

### [Detecting Operation of Paper Width Detection Mechanism]

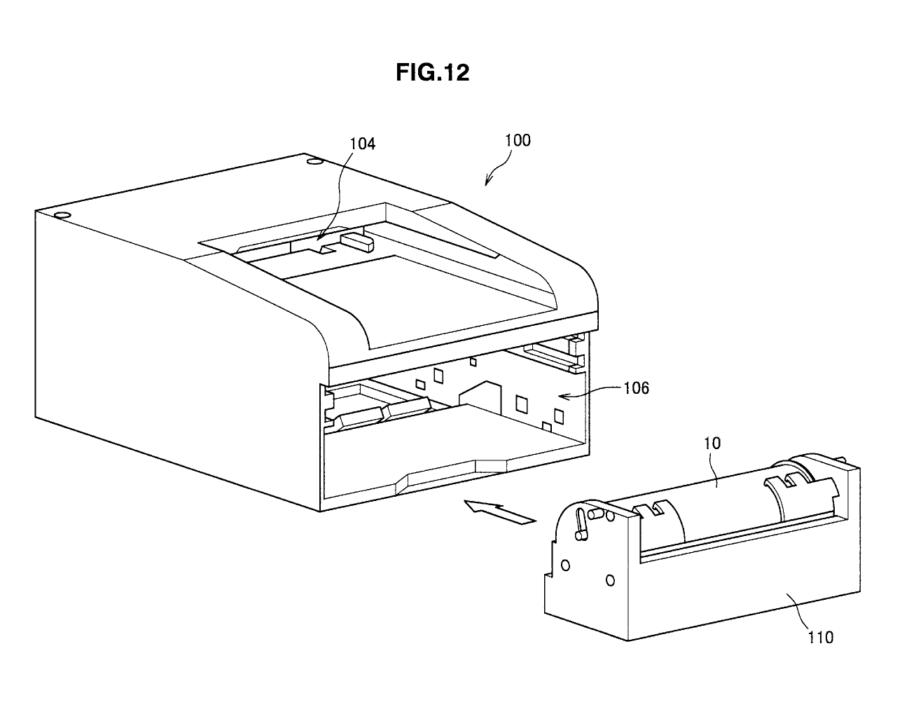

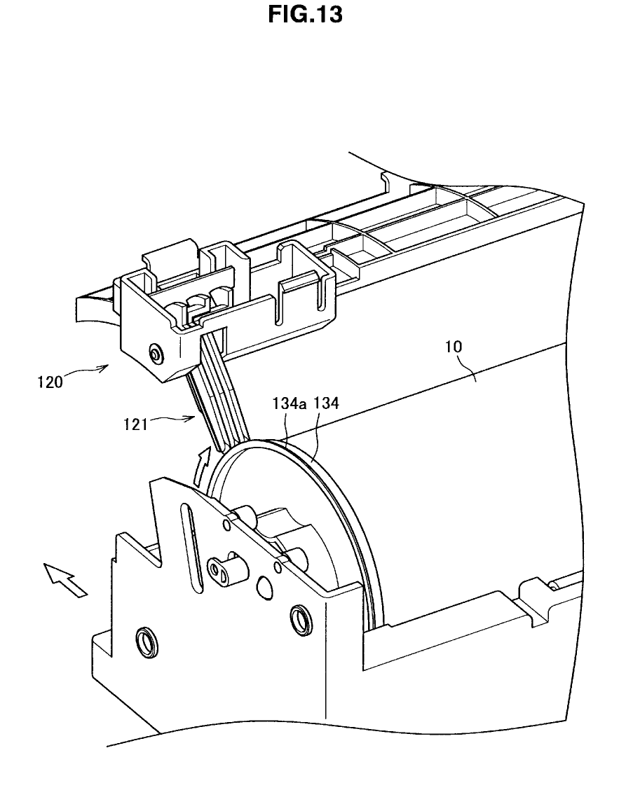

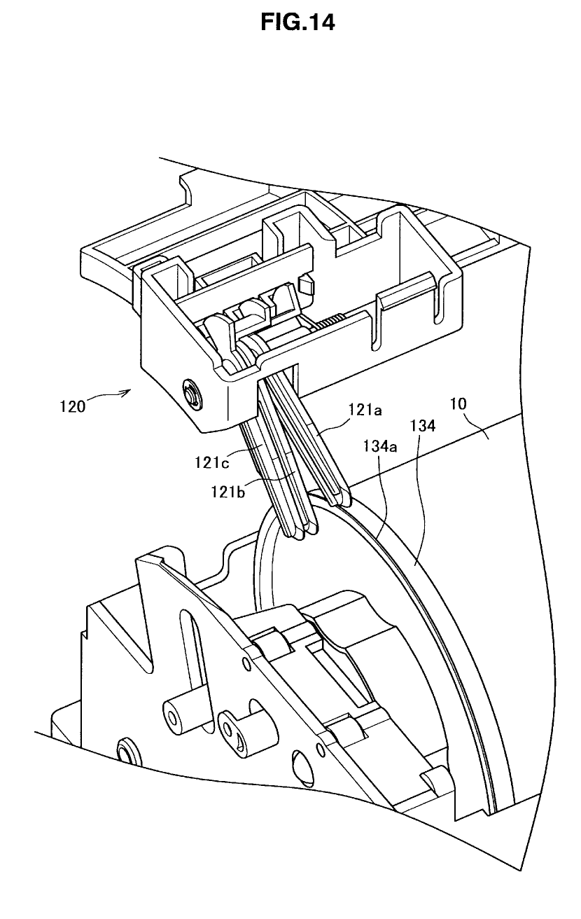

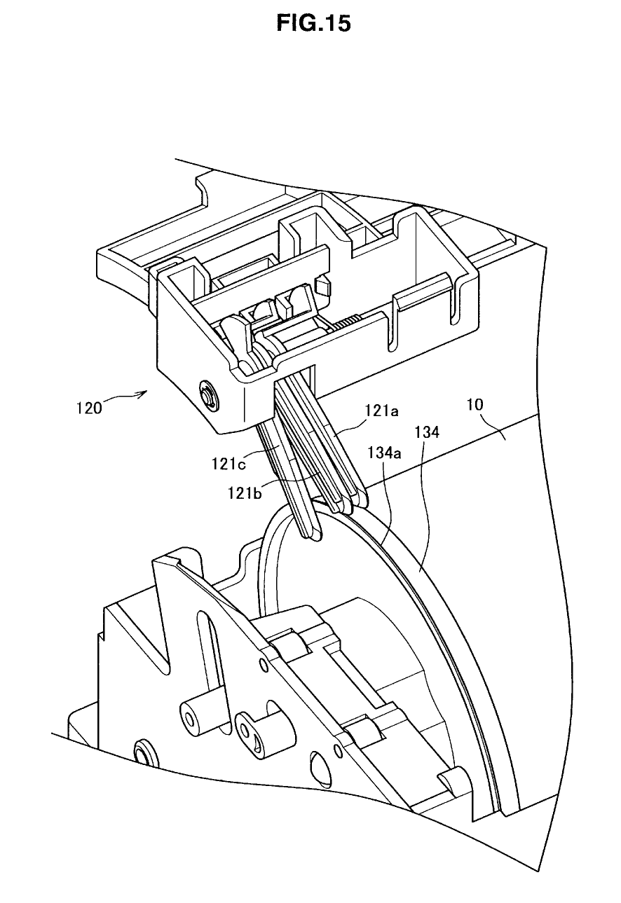

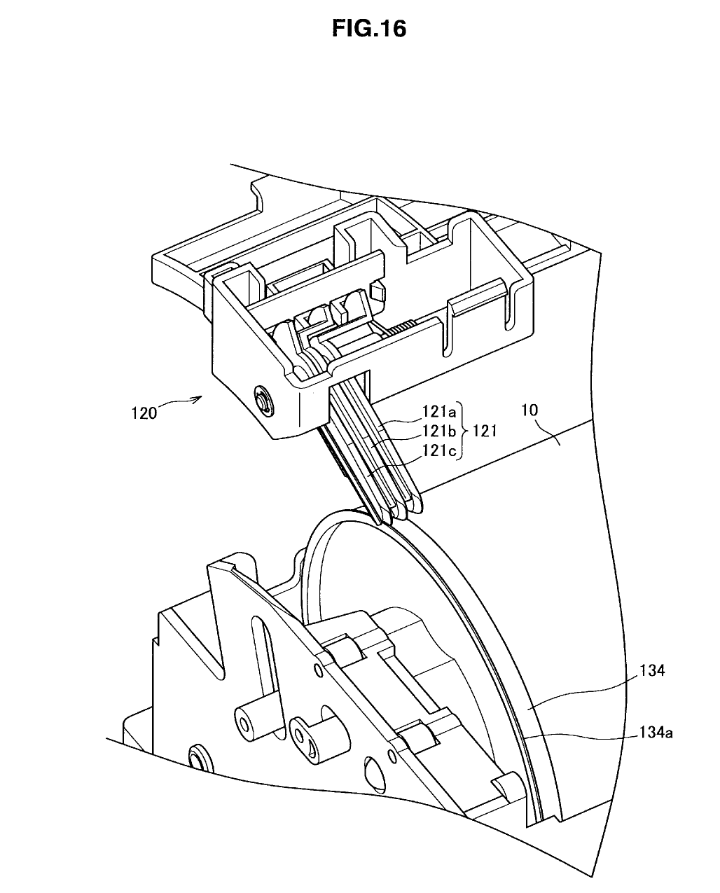

The paper width detecting operation of the recording paper roll by the paper width detection mechanism 120 will now be described based on FIGS. 12 to 16. FIG. 12 is an explanatory view showing a state in which the recording paper roll loading unit 110 is attached to the housing 102 of the image forming apparatus 100. FIG. 13 is an explanatory view showing the operation of the lever member 121 in the attachment of the recording paper roll loading unit 110 to the housing 102. FIG. 14 is an explanatory view showing a state in which the first lever member 121a is contacting the flange unit 134. FIG. 15 is an explanatory view showing a state in which the second lever member 121b is contacting the flange unit 134. FIG. 16 is an explanatory view showing a state in which the third lever member 121c is contacting the flange unit 134.

The operation of when detecting the paper width of three types of recording paper roll 10 with three lever members 121 will be described herein. The sizes of the three types of recording paper roll 10 are eight inch size (203 mm), A4 size (210 mm), and LT size (216 mm). The paper width detection mechanism 120 according to the present embodiment can accurately detect the paper width even if the sizes of the three types differ by only a few millimeters. This is because the lever member 121 can be arranged in close proximity by reducing the thickness of the lever member 121 (x-axis direction, i.e., paper width direction). In this case, the ribs 211g, 212g, 213g are formed at the main body units 211a, 212a, 213a to reinforce the thinned lever member 121.

First, as shown in FIG. 12, the recording paper roll loading unit 110 according to the present embodiment accommodates the recording paper roll 10 held by the holder 130, and is attached to the image forming apparatus 100 from the opening 106 of the housing 102. In the initial state of before the recording paper roll loading unit 110 is attached to the housing 102, all of the three lever members 121 of the paper width detection mechanism 120 are in a state drooped in the z-axis negative direction. When the recording paper roll loading unit 110 is pushed into the image forming apparatus 100, the lever member 121 of the paper width detection mechanism 120 arranged inside the image forming apparatus 100 contacts the peripheral surface of the flange unit 134 of the holder 130 holding the recording paper roll 10, as shown in FIG. 13. In this case, at least one of the three lever members 121 contacts the flange unit 134, and rotates in the counterclockwise direction along the peripheral surface thereof.

Among the recording paper roll 10 that can be accommodated in the recording paper roll loading unit 110, the detection of the recording paper roll 10 having the narrowest paper width (i.e., eight inch size (203 mm)) is performed by the first lever member 121a. When the recording paper roll loading unit 110 accommodating such recording paper roll 10 is pushed into the housing 102, the first lever member 121a contacts the flange unit 134. The first lever member 121a rotates along the peripheral surface of the flange unit 134 with the pushing in of the recording paper roll loading unit 110 into the housing 102.

When the recording paper roll loading unit 110 is attached to the image forming apparatus 100, only the first lever member 121a of the lever member 121 is rotatable, as shown in FIG. 14. In this case, the second lever member 121b and the third lever member 121c, which are positioned on the outer side in the paper width direction than the first lever member 121a, are still in the drooped state. As shown in FIG. 14, in a state the first lever member 121a is rotated, only the detecting unit 122a detects the back end 211b of the first lever member 121a. The determination unit determines that the paper width of the recording paper roll 10 accommodated in the recording paper roll loading unit 110 is 203 mm from the detection result of the detecting unit 122.

Furthermore, among the recording paper roll 10 that can be accommodated in the recording paper roll loading unit 110, the detection of the recording paper roll 10 of A4 size (210 mm) is performed by the second lever member 121b. When the recording paper roll loading unit 110 accommodating such recording paper roll 10 is pushed into the housing 102, the second lever member 121b contacts the flange unit 134. The second lever member 121b rotates along the peripheral surface of the flange unit 134 with the pushing in of the recording paper roll loading unit 110 into the housing 102. In this case, the first lever 121a positioned on the inner side in the paper width direction than the second lever member 121b also rotates with the rotation of the second lever member 121b.

In other words, when the thin-thickness portion 212m of the second lever member 121b contacts the peripheral surface of the flange unit 134 and rotates to the upper side of the plane of drawing of FIG. 15, the projection 212f of the second lever member 121b that engages the recess 211e of the first lever member 121a pushes up the first lever member 121a. Thus, since the first lever member 121a cooperatively rotates with another lever member 121b, 121c positioned on the outer side in the paper width direction than itself, the contact of the first lever member 121a and the outer peripheral surface of the recording paper roll 10 can be prevented.

The third lever member 121c positioned on the outer side in the paper width direction than the second lever member 121b maintains a state in which the contacting part is drooped even if the second lever member 121b is rotated. In other words, the engagement of the recess 212e of the second lever member 121b and the projection 213f of the third lever member 121c in a state in which the second lever member 121b and the third lever member 121c are drooped is disengaged by the rotation of the second lever member 121b. Therefore, the third lever member 121c does not rotate by the rotation of the second lever member 121b.

In the state shown in FIG. 15, the detecting unit 122a corresponding to the first lever member 121a and the detecting unit 122b corresponding to the second lever member 121b detect the rotation of the lever members 121a, 121b. The determination unit determines that the paper width of the recording paper roll 10 accommodated in the recording paper roll loading unit 110 is 210 mm from the detection result of the detecting unit 122.

Moreover, among the recording paper roll 10 that can be accommodated in the recording paper roll loading unit 110, the detection of the recording paper roll 10 of LT size (216 mm) is performed by the third lever member 121c. When the recording paper roll loading unit 110 accommodating such recording paper roll 10 is pushed into the housing 102, the third lever member 121c contacts the flange unit 134. The third lever member 121c rotates along the peripheral surface of the flange unit 134 with the pushing in of the recording paper roll loading unit 110 into the housing 102. In this case, the first lever member 121a and the second lever member 121b positioned on the inner side in the paper width direction than the third lever member 121c also rotate with the rotation of the third lever member 121c.

In other words, when the thin-thickness portion 213m of the third lever member 121c contacts the peripheral surface of the flange unit 134 and rotates to the upper side of the plane of drawing of FIG. 16, the projection 213f of the third lever member 121c that engages the recess 212e of the second lever member 121b pushes up the second lever member 121b. Furthermore, the projection 212f of the second lever member 121b that engages the recess 211e of the first lever member 121a pushes up the first lever member 121a. Thus, since the first lever member 121a and the second lever member 121b cooperatively rotate with the third lever member 121c positioned on the outer side in the paper width direction than themselves, the contact of the first lever member 121a and the second lever member 121b with the outer peripheral surface of the recording paper roll 10 can be prevented.

In the state shown in FIG. 16, the detecting units 122a, 122b, 122c corresponding to the three lever members 121a, 121b, 121c detect the rotation of the three lever members 121a, 121b, 121c. The determination unit determines that the paper width of the recording paper roll 10 accommodated in the recording paper roll loading unit 110 is 216 mm from the detection result of the detecting unit 122.

Therefore, the paper width detection mechanism 120 according to the present embodiment can detect the paper width of the recording paper roll 10 accommodated in the recording paper roll loading unit 110 by the number of rotated lever members 121 detected by the detecting unit 122. The lever member 121 rotates in conjunction with another lever member 121 positioned on the outer side in the paper width direction than itself. Thus, the lever member 121, which is positioned on the inner side in the paper width direction than the lever member 121 that contacts the peripheral surface of the flange unit 134 and rotates, contacts the outer peripheral surface of the recording paper roll 10, thereby preventing taint damage of the recording paper, and production of small scratches and paper powder.

The configuration and the operation of the paper width detection mechanism 120 according to the present embodiment have been described above. According to the paper width detection mechanism 120 according to the present embodiment, a plurality of lever member 121 that contact the flange unit 134 of the holder 130 for holding the recording paper roll 10 is arranged according to the paper size of the recording paper roll 10 accommodated in the recording paper roll loading unit 110. One lever member 121 contacts the flange unit 134 and rotates with the pushing in of the recording paper roll loading unit 110 into the housing 102. When the recording paper roll loading unit 110 is accommodated in the housing 102, the detecting unit 122 detects the rotated lever member 121. The paper width detection mechanism 120 can detect the paper width of the recording paper roll 10 accommodated in the recording paper roll loading unit 110 from the detection result of the detecting unit 122. Thus, the paper width detection mechanism 120 can immediately detect the paper width of the recording paper roll 10 before passing the recording paper through the apparatus with a simple configuration of lining a plurality of lever members 121 and detecting the rotation state of the lever members 121 with the detecting unit 122.

The plurality of lever members 121 of the paper width detection mechanism 120 according to the present embodiment is configured to rotate in conjunction with another lever member 121 positioned on the outer side in the paper width direction than itself. Thus, the lever member 121 does not contact the surface of the recording paper roll 10 regardless of which recording paper roll 10 of which paper width is accommodated in the recording paper roll loading unit 110. Thus, the taint damage and production of small scratches and paper powder, etc. at the surface of the recording paper roll 10 can be prevented. The mistaken detection of the paper size due to the influence of undulation of the surface of the recording paper roll 10 can be prevented.

It should be understood by those skilled in the art that various modifications, combinations, sub-combinations and alterations may occur depending on design requirements and other factors insofar as they are within the scope of the appended claims or the equivalents thereof.

For instance, in the embodiment described above, three lever members 121a, 121b, 121c are arranged in the paper width detection mechanism 120, but the present invention is not limited to such example. For instance, a plurality of lever members 121 may be arranged according to the size of the recording paper roll 10 that can be accommodated in the recording paper roll loading unit 110. The material of the lever member 121 is also not limited to the example of the above-described embodiment.

In the above-described embodiment, the guide unit 134a formed at the flange unit 134 is a projection-shaped guide projected out in the radial direction, but the present invention is not limited to such example, and may be a recess-shaped guide depressed in the radial direction. The guide unit 134a is arranged on the outer side in the paper width direction of the flange unit 134, but the present invention is not limited to such example, and may be arranged on the inner side in the paper width direction of the flange unit 134.

Furthermore, in the above-described embodiment, the sublimation thermal printer device is used for the image forming apparatus 100, but the present invention is not limited to such example. The device is to be an image forming apparatus that uses the recording paper roll 10, and may be applied to an inkjet printer or a laser printer, or may be a device other than a printer (e.g., copying machine, facsimile).

The present application contains subject matter related to that disclosed in Japanese Priority Patent Application JP 2008-335252 filed in the Japan Patent Office on Dec. 26, 2008, the entire content of which is hereby incorporated by reference.

What is claimed is:

1. A paper width detection apparatus, comprising:
a plurality of lever members lined in parallel in a paper width direction of a recording paper roll attached to a recording paper roll loading unit, each lever member being rotatably arranged on a same center axis;
a detecting unit for detecting a rotation state of the lever member; and
a determination unit for determining a paper width of the recording paper roll based on a detection result detected by the detecting unit;
wherein one lever member of the plurality of lever members rotates in a first rotating direction about the center axis by contacting an outer peripheral part of a holding unit for holding both ends of the recording paper roll, and
another lever member positioned on an inner side in the paper width direction facing the recording paper roll than the lever member contacting the holding unit rotates in conjunction with the lever member contacting the outer peripheral part of the holding unit.

2. The paper width detection apparatus according to claim 1, wherein
a second lever member positioned on an outer side in the paper width direction of the lever members adjacent in the paper width direction includes a projection projecting towards a first lever member positioned on the inner side in the paper width direction, and
when the second lever member rotates in the first rotating direction, the projection of the second lever member contacts the first lever member, and the first lever member rotates with the second lever member.

3. The paper width detection apparatus according to claim 1, wherein
the lever member includes,
a main body unit having a contacting part, which contacts the outer peripheral part of the holding unit, at one end and a through-hole to be inserted with the center axis on another end, and
a back end which is coupled to the other end of the main body unit and which rotation state is detected by the detecting unit, and
the determination unit determines the paper width of the recording paper roll based on number of detections the back end is detected by the detecting unit by the rotation of the lever member.

4. The paper width detection apparatus according to claim 3, wherein
one lever member of the plurality of lever members contacts an outer peripheral surface of a flange unit and rotates in the first rotating direction when the recording paper roll loading unit is inserted to a housing from an initial state in which the lever member is drooped such that the contacting part is positioned on an upper side than a center of rotation of the recording paper roll loading unit; and
the one or more rotated lever members return to the initial state when the recording paper roll loading unit is pulled out from the housing.

5. The paper width detection apparatus according to claim 4, further comprising an elastic member for biasing the lever member in a second direction opposite to the first rotating direction.

6. An image forming apparatus comprising:
a recording paper roll loading unit, detachably arranged with respect to a housing, for accommodating a recording paper roll formed by rolling up a recording paper to a roll-form;
a paper width detection mechanism for detecting a paper width of the recording paper roll accommodated in the recording paper roll loading unit;
a paper conveying unit for conveying the recording paper;
a printing unit for performing a printing process on the recording paper conveyed by the paper conveying unit; and
a cutting unit for cutting a printed region printed by the printing unit of a recording medium,
wherein the paper width detection mechanism includes,
a plurality of lever members lined in parallel in the paper width direction of the recording paper roll attached to the recording paper roll loading unit, each lever member being rotatably arranged on a same center axis,
a detecting unit for detecting a rotation state of the lever member, and
a determination unit for determining the paper width of the recording paper roll based on a detection result detected by the detecting unit,
one lever member of the plurality of lever members rotates in a first rotating direction about the center axis by contacting an outer peripheral part of a holding unit for holding both ends of the recording paper roll, and
another lever member positioned on an inner side in the paper width direction facing the recording paper roll than the lever member contacting the holding unit rotates in conjunction with the lever member contacting the outer peripheral part of the holding unit.

7. The image forming apparatus according to claim 6, wherein
the holding unit includes,
a fixed unit inserted to a center part of the recording paper roll to act as a rotation shaft of the recording paper roll, and
a movable unit on a circular plate, coupled to the fixed unit, for regulating an end face position of the recording paper roll, and
a guide unit projected or recessed in a radial direction is formed along a peripheral direction at an outer peripheral part, which is an outer edge of the movable unit.
